(19) United States
(12) Patent Application Publication
(10) Pub. No.: US 2026/0262564 A1
(43) Pub. Date: Sep. 10, 2026

(54) METHOD AND SYSTEM FOR DELIVERING CLOSED-LOOP NUTRIENT MANAGEMENT

(71) Applicant: Upside Robotics Inc., Kitchener (CA)

(72) Inventors: Jana TIAN, Kitchener (CA); Sam DUGAN, Kitchener (CA)

(21) Appl. No.: 19/562,058

(22) Filed: Mar. 10, 2026

Related U.S. Application Data
(60) Provisional application No. 63/769,251, filed on Mar. 10, 2025.

(51) Int. Cl. A01C 21/00; A01C 23/00; G06V 20/10

(52) U.S. Cl. CPC A01C 21/005; A01C 23/007; G06V 20/188

(57) ABSTRACT

An autonomous agricultural management system implementing closed-loop optimization through real-time sensor fusion and dynamic zone management. The system utilizes an autonomous robotic platform with multi-sensor arrays and variable-rate application capabilities, integrated with a base station for environmental monitoring. Machine learning algorithms process sensor data to optimize nutrient application, while cross-zone performance validation enables continuous system adaptation.

### CROSS-REFERENCE TO OTHER APPLICATIONS

The present disclosure claims priority from US Provisional Application No. 63/769,251 filed Mar. 10, 2025 which is hereby incorporated by reference.

### FIELD

The present disclosure generally relates to precision agriculture systems and more specifically to an autonomous robotic platform for delivering closed-loop nutrient management.

### BACKGROUND

Traditional precision agriculture systems often rely on static management zones and predetermined application rates, limiting their ability to adapt to changing field conditions. While variable-rate technology exists, current systems lack real-time adaptation capabilities and cross-zone performance validation. Furthermore, existing solutions do not effectively integrate multiple data streams for dynamic prescription adjustment.

Therefore, there is provided a novel method and system for closed-loop nutrient management delivery in an uncontrolled environment.

### SUMMARY

In one aspect of the disclosure, there is provided a method for generating a nutrient management plan for crops in a field including selecting high and low growth calibration points withing the field; obtaining high and low growth calibration point images; obtaining digital information associated with the crops while delivering nutrients to the crops in the field; processing the digital information; and updating the nutrient management plan based on the comparison.

In another aspect, obtaining digital information associated with the crops includes obtaining images or a video stream of crops within the field. In a further aspect, obtaining images or a video stream of crops within the field includes obtaining images or video stream of crops above and below the robot. In yet another aspect, obtaining digital information associated with the crops includes determining at least one of weather conditions or soil conditions within the field.

In another aspect of the disclosure, there is provided a system for nutrient delivery including a set of wheels; at least one storage tank for storing at least one nutrient for the nutrient delivery; a nutrient delivery component; a set of cameras; and a processor for storing and controlling the system for nutrient delivery to execute a nutrient delivery plan based on zoned methodology.

In another aspect, the set of cameras includes at least one of a multispectral camera, a hyperspectral camera or a RGB camera. In a further aspect, the system further includes a set of sensors. In yet another aspect, the set of sensors includes at least one of temperature sensors, humidity sensors, pressure sensors, inertial measurement unit (IMU) sensor, a compass, a motion position sensor, a pump position sensor, a tank level sensor, flow/liquid flow measurement sensors or a battery level or feedback sensor. In a further aspect, the system includes a set of charging pads. In another aspect, the nutrient delivery component includes a nozzle module for delivering the nutrients.

### BRIEF DESCRIPTION OF THE DRAWINGS

Some embodiments of the present disclosure are illustrated as an example and are not limited by the figures of the accompanying drawings, in which like references may indicate similar elements and in which:

FIG. 1 is a perspective view of an apparatus for nutrient delivery;

FIG. 2 is a schematic diagram of a gridded field;

FIG. 3a is schematic diagram of a base station for use with the apparatus for nutrient delivery;

FIG. 3b is a perspective view of another embodiment of a base station for use with the apparatus for nutrient delivery;

FIG. 4 is a flowchart showing a method of closed-loop nutrient management through a dynamic zone-based optimization or methodology; and

FIG. 5 is a flowchart showing a method of determining nutrient delivery with respect to a soil moisture level.

### DETAILED DESCRIPTION OF THE EMBODIMENTS

The disclosure is directed at methods and systems for closed-loop feedback control nutrient management. In one embodiment, the disclosure is directed at the delivery of nutrients, crop amendment goods or fertilizer (referred to in the following as “nutrients”) through a dynamic zones methodology. In one embodiment, the disclosure includes an autonomous nutrient feeding machine or robot that is used to provide nutrients to a field based on a nutrient management plan where the nutrient management plan is generated via the dynamic zones methodology. As the robot is delivering nutrients to crops in a field, the robot is also capturing digital information (such as in the form of images, videos or sensor measurements) for updating the nutrient management plan based on the dynamic zones methodology. The nutrient management plan may be updated dynamically (as the robot is delivering the nutrients in the field) or between delivery tasks (after the robot returns to a base station).

In some embodiments, the disclosure may include in-row autonomy functionality whereby as the robot is performing nutrient delivery in a field that is defined by rows of crops, the robot includes components and code to be able to navigate through the field when there are obstructions in the robot path. These may be partially or fully obstructed paths that are captured by the cameras. In some embodiments, the in-row autonomy functionality may instruct the robot to drive through the obstruction whereby there may not be damage to the robot (i.e. leaves) or may instruct the robot to not drive through the obstruction whereby there may be damage to the robot (i.e. rocks).

In other embodiments, the in-row autonomy functionality of the disclosure is able to assist in navigating movement of the robot when the robot is unable to communicate with the navigation system such as a GPS system. The in-row autonomy functionality or component is also able to assist the robot in navigating uneven or rough terrain. The in-row autonomy functionality or component may also assist to navigate the robot during day or night as it will make adjustments in response to environmental lighting to assist the robot and the robot's movement.

In some aspects, the disclosure may include a path planning component or module to generate a path for the robot to follow within the field for the nutrient delivery based on different parameters in order to enable the robot to travel a most efficient path. The path planning component may rely on vector-based navigation and/or planning to enable higher travel or path accuracy for larger fields. The path planning component may be integrated or incorporated with the nutrient management plan.

In one embodiment, the feeding machine includes a processor that stores and executes code to provide the nutrients to a set of crops based on the nutrient management plan generated or designed via the dynamic zones methodology.

In some embodiments, the disclosure is directed at an agricultural management system that overcomes limitations of current systems through at least one of dynamic zone management, real-time sensor fusion and automated prescription adjustment based on cross-zone performance comparison.

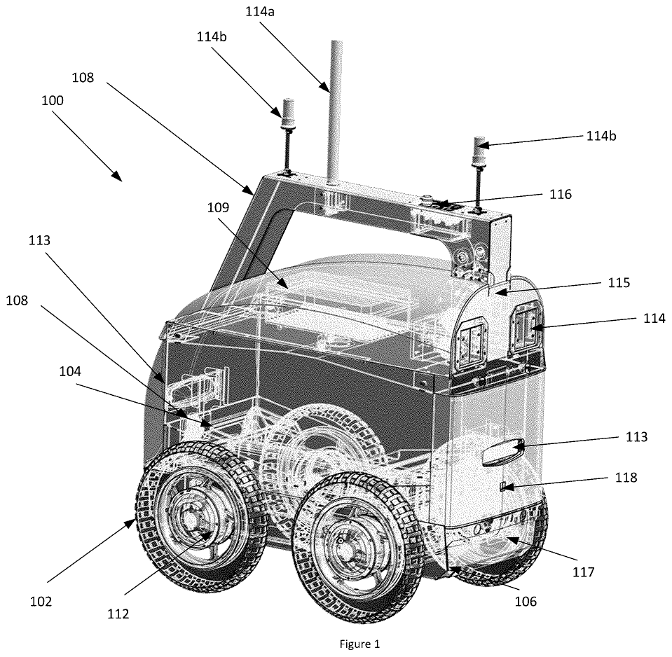

Turning to FIG. 1, a perspective view of an autonomous nutrient feeding machine or robot is shown. In some embodiments, the machine or robot is used to deliver nutrients to a set of crops within a field. In some embodiments, the robot may be seen as a small and lightweight robot or robotic unit that has a low or minimal effect on soil compaction as it is in operation. The robot of the disclosure may also not be constrained by traditional equipment windows.

In the current embodiment, robot 100 includes a set of wheels 102 that enable the robot to travel from a garage location or base station to the field in order to provide the nutrients to the set of crops located in the field. The robot 100 further includes at least one tank 104, such as, but not limited to a stainless steel tank, for storing one or more liquid or solid nutrients that are delivered to the crops and a nutrient delivery module (or spray module component) 106 that is able to deliver the nutrient(s) to the crops as the robot 100 travels along a designated path within the field. In some embodiments, the at least one tank may be able to hold or store more than one nutrient where the at least one tank includes walls separating the tank into different compartments. The robot 100 further includes a motor 112 which in some embodiments may be integrated with the wheels 102. The robot 100 may further include a set of charging pads 114 that are used when the robot 100 returns to a base station so that its battery 117 can be charged. In some embodiments the charging pads are copper charging pads. Proximate the charging pads 114 is a refill port 115 which can be used to replenish the nutrients in the storage tank.

Front and rear lights 113 for assisting in illuminating areas surrounding the robot are mounted to a front and rear of the robot. It is understood that other lighting on the sides, the top and bottom of the robot may also be contemplated.

In some embodiments, the robot 100 may include more than one tank that stores the solid or liquid nutrients. For this embodiment, robot 100 may include a distributed reservoir system that connects outputs of the different tanks to allow the nutrients stored within to be blended or mixed prior to application or nutrient delivery. This may be seen as an on-board ratio blending apparatus. The mixing of the different nutrients may be determined based on analysis of the crops. Alternatively, the output of the more than one tank may be connected to a single collector tank for receiving the different nutrients to produce a nutrient recipe. The single output tank may include a mixing apparatus for mixing the nutrients together.

Depending on the type or nature of the nutrients, i.e. liquid or solid, the nutrient delivery module 106 includes apparatus for delivering the nutrients. For example, if liquid nutrients are being delivered, the nutrient delivery module 106 may include a nozzle portion for delivering the nutrients. The nutrients from the tank may be delivered to the nozzle portion via gravity or the nutrients may be pumped, such as via a pump component, from the tank to the nozzle portion. In some embodiments, the nozzle portion may include Y-drop adjustable nozzles for application of liquid nutrients. Alternatively, if solid nutrients are being delivered, the nutrient delivery module may include a spreader apparatus for delivering the nutrients. In some embodiments, the nutrients are delivered at a root zone of the crop with surface-level precision placement. This may be controlled or facilitated via the nozzle geometry. The placement of the nutrients can be controlled via signals that are transmitted to the nutrient delivery module. In other embodiments, a pressure or size of a droplet of the nutrient application may also be controlled by the CPU 109. In other embodiments, the robot may deliver the nutrients proximate to the plant stem with a low-disturbance surface application.

In the current embodiment, the robot 100 further includes a set of cameras 108 (seen as circles within FIGS. 1a and 1b) that are connected to a central processing unit (CPU) 109 to provide digital information or data (such as in the form of images or a video stream) to the CPU 109. The CPU 109 may process the digital information to update a nutrient management plan on a real-time basis or may store the digital information for later processing to update the nutrient management plan using a dynamic zone methodology. This will be described in more detail below.

The robot 100 may also provide the digital information to remote servers. In some embodiments, the CPU 109 processes the digital information to perform functions such as, but not limited to, determine current weather status, assist in navigation, determine soil state, update the nutrient management plan and/or determine crop status.

In the current embodiment, the set of cameras 108 may include a multispectral camera 108 located within the tank 104 and a pair of RGB cameras 108 located at a front and a back of the robot 100. It is understood that integration of other cameras within the robot 100 or positioning the cameras in different locations may be contemplated. The set of cameras 108 may also include a canopy sensor camera which is directed at positions above the robot. In at least one embodiment, the multispectral camera 108 may be used to analyze leaves of the crops (either above or below the robot 100) as the robot traverse the field. If present, the canopy sensor camera may be used to monitor plant or crop developments and/or sky conditions. It is understood that while specific types of cameras have been disclosed, other types of cameras, such as, but not limited to a hyperspectral camera, may also be used without affecting the scope of the disclosure or innovation.

In order to communicate with other electronic devices, such as to transmit or receive instructions, signals, data, images and the like, the robot 100 includes a communications antenna 114a that facilitates such communication. Communication may be performed using known communication protocols.

The robot 100 may also include a set of sensors 116 (seen as squares in FIGS. 1a and 1b) that may provide different types of digital information to the processor 109 or a remote server such as, but not limited to, analytic information associated with the nutrient delivery and/or the weather conditions (i.e. temperature, humidity, soil moisture level and the like). Different sensors that are contemplated include, but are not limited to, temperature sensors, humidity sensors, pressure sensors, inertial measurement unit (IMU) sensor, a compass, a motion position sensor, a pump position sensor, a tank level sensor, flow/liquid flow measurement sensors or a battery level or feedback sensor.

Based on stored instructions or instructions transmitted in real-time from a remote server, after the robot 100 reaches the field, the robot 100 may then travel in a predetermined manner or path to provide nutrients to the crops in the field. This may be seen as a nutrient management or delivery plan. As discussed below, the field may be divided into different zones or sectors.

In some embodiments, the path of motion of the robot 100 may be pre-stored within the CPU 109. In other embodiments, the path of motion of the robot may be controlled remotely via signals transmitted from a remote server or communication device or the path of motion of the robot may be assisted or guided with global positioning (GPS) technology. In some embodiments, a GPS system within the robot 100 may include real-time kinematic (RTK) positioning technology that is facilitated via a set of RTK GPS antennas 114b.

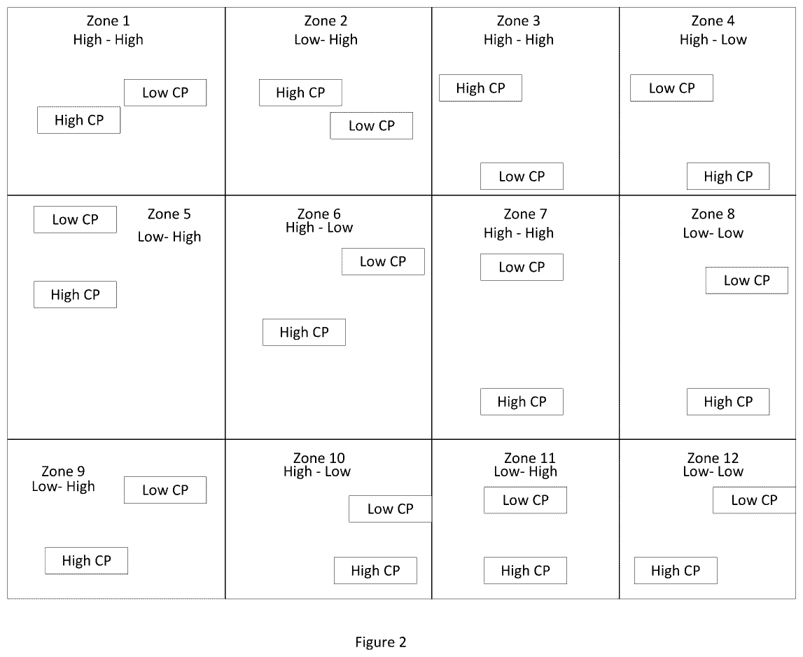

Turning to FIG. 2, a schematic diagram of a field divided into zones is shown. As shown, the field 200 is divided into twelve differently sized zones (labeled Zone 1 to Zone 12). In some embodiments, the zones may be defined or classified as areas within a field that have similar characteristics to other areas within the field based on determined parameters without respect to physical location within the field. For example, Zone 1 may represent all areas within the field that have an elevation within a predetermined range and a gradient range with respect to the ground. In other embodiments, the nutrient management plan for a zone may include different nutrient delivery rates within a zone and/or the zone may have more than one nutrient management plan. It is understood that the field 200 which the robot is performing the nutrient delivery does not need to be rectangular, however, FIG. 2 is shown as a rectangle for ease of reference. This also holds for the shapes of the zones in the schematic diagram of FIG. 2. In some embodiments, the zones may not necessarily need to be a quadrilateral but may be any type of shape as desired. For example, the zones may be somewhat circular, the zones may or may not have symmetry. They may also be similarly or differently sized. The dimensions, shapes and locations of the different zones within the field will be known beforehand and stored within the processor 109 in the robot 100 and/or the remote server which transmits path information to the robot 100 in real-time. The zone dimensional characteristics may be based on GPS coordinates or may be plotted or mapped based on an understanding of distances and lengths. Alternatively, the zones may be defined with physical markers that are sensed by the robot as it travels in the field between zones. Alternatively, a gamma radiation sensor may be used to sense zones that are previously outlined using gamma radiation.

As will be understood, each zone within the field may experience different environmental conditions and/or different crop health. For example, even if all the zones experience the same rainstorm, due to drainage differences, some zones may retain water more than other zones. Also, the crops in some zones may be growing better than in other zones. Each of the specific zone conditions may be determined, received and processed by the system in order to deliver nutrients using the zone-based methodology. By controlling the level of nutrient delivery due to zone characteristics or the dynamic zone methodology, the disclosure is able to provide an improved nutrient delivery system with different advantages over current systems. For example, by only providing nutrients where necessary or by providing a level of nutrients that are beneficial for the crops in a zone, the system experiences less wasted nutrients.

Initially, each of the zones 200 includes designated high and low growth calibration points (CP) or areas. These may also be seen as predetermined or preselected areas within the zones that have crops that display or have indications of higher and lower growth rates within a specific zone. The calibration points may serve as reference points for how crop growth is going for the remaining areas within the zone. The selection of the designated or location of the high and low growth calibration points or areas may be based on historical research or may be randomly selected. The low growth calibration point may be seen as an area receiving minimal nutrient application (intentionally nutrient-limited) or experiencing a less than optimal or predicted growth rate, while the high growth calibration point may be seen as an area receiving optimal or excessive nutrient levels (ensuring nutrients aren't limiting growth).

In use, each of the low and high calibration points are associated with images of low and high performing crops for the system to compare with during the nutrient delivery. As the robot passes through the low and high calibration point areas, the robot obtains images of the crops for comparison with images of other areas within the zone to determine areas within the zone that are experiencing higher or lower growth. Alternatively, the robot may compare the images of other areas or the images taken at the calibration point areas within the zone with previously stored high and low calibration point images. The robot may also obtain images reflecting topography and/or elevation data or images.

This creates a performance spectrum within each zone. By comparing the performance of the different areas within the zone against these calibration points i.e. by comparing images obtained by one of the set of cameras 108 integrated with the robot 100 to images associated with crop performance at the low or high calibration point areas, the system can determine if current nutrient application or delivery for that zone is appropriate. In other words, the system may determine in real-time if the nutrient management plan should be updated based on real-time images of how crops are performing. Alternatively, the system may update the nutrient management plan based on this image comparison in between nutrient delivery tasks.

When zone performance (or the images captured by the cameras) resembles the low calibration point images (showing nutrient deficiency symptoms or less optimal performance), it may indicate under-application or that the crops are not growing at their optimal or expected rate and therefore, the nutrient management plan may be updated to improve crop performance, such as to, but not limited to, increase nutrient delivery for the zone (assuming other delivery conditions are met). When zone performance (or the images captured by the cameras) matches the high calibration point images, it suggests optimal nutrient levels and therefore, the nutrient management plan may not need to be updated or may be updated to decrease nutrient delivery for the zone (assuming other delivery conditions are met). This relative comparison approach eliminates or reduces the need for complex variable-by-variable analysis, providing clear, actionable insights without requiring detailed scientific understanding of each potential limiting factor. Based on these comparisons, in some embodiments, each zone may be classified as high-high; high-low; low-high and/or low-low (as schematically shown in FIG. 2) with respect to two variables being determined such that the first part of the zone classification represents a health or level of one variable and the second part of the zone classification represents a health or level of a second variable. Other zone classifications methodologies may be used and more than two variables may be classified.

With respect to a relationship between zone classifications and calibration point determinations, the zone classifications may represent different nutrient application prescriptions. For example, if the nutrient being delivered is nitrogen, the classifications may be determined as outlined below. In one specific example, the classifications are initially determined based on a predetermined formula

As an initial calculation, the values in the formula may be determined using soil tests (nutrient levels and texture analysis), historic yield data, and field characteristics for each of the zones before any nutrient delivery has been delivered or the field has been divided into zones. In some embodiments, areas within the field having similar attributes are grouped into management zones or designated as zones with identical classifications such that each of the zones receives tailored nutrient application rates such as, but not limited to nitrogen application rates, macronutrient application rates, secondary nutrient application rates and/or micronutrient application rates. The calibration points enable continuous validation of these prescriptions against actual field performance, providing ground-truth feedback on the algorithm's effectiveness. It is understood that other equations or formulas may be used for the classification.

In one embodiment, an initial nutrient management plan may be determined based on the above-identified formula using baseline nutrient levels or field variables from comprehensive testing, several variables in the formula may be continuously updated. For example, the growing degree days (temperature-based uptake); rainfall measurements; nitrogen mineralization (weather-dependent) and/or nitrogen leaching (moisture-dependent). In some embodiments, the variables with respect to the nutrient management plan may be referred to as static variables where properties do not change and continuous variables where properties change on a regular basis.

The calibration point comparison enables both in-field adjustments and post-application refinements. When significant performance differences appear between different crop images within a zone and the high checkpoint images of that zone, the system can implement manual adjustments to nutrient levels until performance aligns more closely with the optimal checkpoint or the high checkpoint images. This creates a feedback loop that continually refines nutrient delivery.

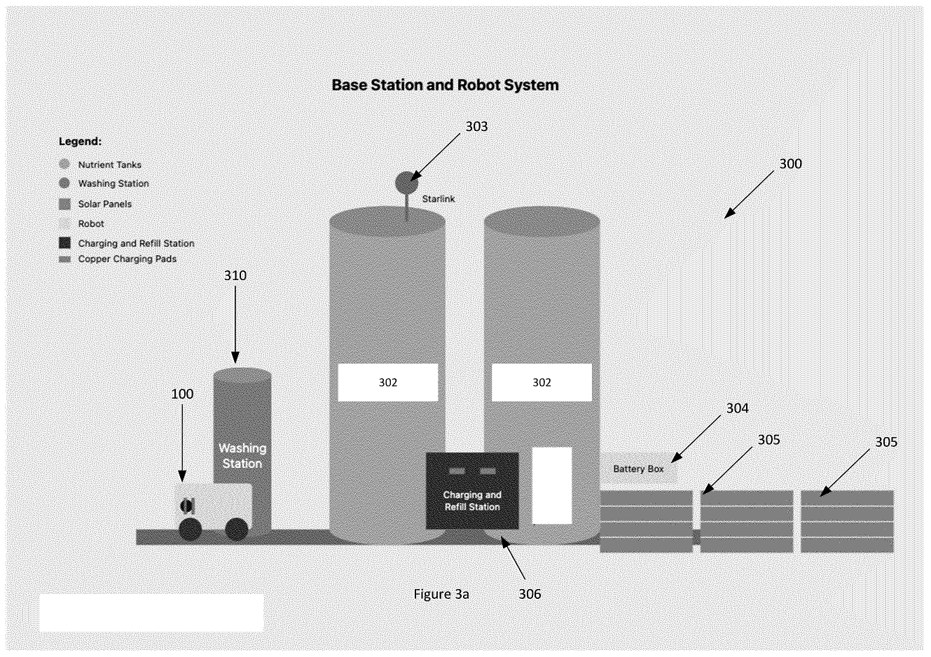

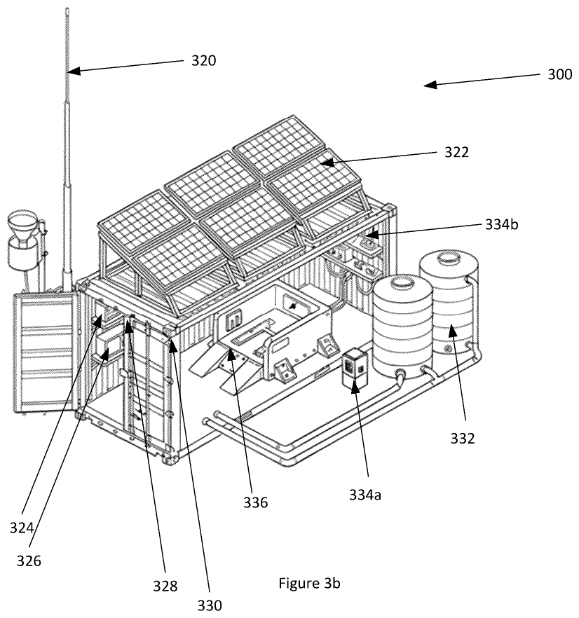

Turning to FIG. 3a, a schematic diagram of the robot and a base station is shown. The base station 300 may be seen as a base or location where the robot may return to after it has completed a nutrient delivery task or any other task. After performing a nutrient delivery task (or the nutrient management plan), the robot 100 returns to the base station 300.

The base station 300 includes at least one nutrient tank 302 which stores nutrients so that robot 100 can replenish its stock when it returns to the base station 300. In some embodiments, each of the nutrient tanks 302 may store the same nutrient but in other embodiments, nutrient tanks 302 may store different nutrients in either a liquid or solid form. Similar to the discussion above with respect to the nutrient storage tank within the robot, the at least one nutrient tank 302 may include a reservoir system whereby the different nutrients within the individual nutrient tanks can be mixed and then delivered to the robot for its next nutrient delivery task. In some embodiments, the system includes a processor that monitors or controls the upcoming nutrient delivery tasks and then determines the nutrients (and their dosage) that are required for the next nutrient delivery task such that the nutrients are pre-mixed and do not have to be mixed by the robot. The robot can then be filled with the nutrient recipe for its next nutrient delivery task.

In some embodiments, the base station 300 may be able to house more than one robot 100 whereby the different robots may be delivering the same or different nutrients. In some embodiments, depending on a size of the field, the system may instruct more than one robot to perform a nutrient delivery task for a single field. It is understood that the nutrient delivery task or nutrient management plan that is determined or generated by the system may be divided between any number of robots based on different criteria including, but not limited to, size of battery, size of nutrient tank and the like. In other embodiments, even when the base station 300 is only housing one robot 100, the robot may be delivering different nutrients to the crops in the field whereby nutrient tanks 302 storing more than one type of nutrient or crop amendment feed may be required or necessary.

The base station 300 may include an antenna or communication mechanism 303 enabling communication between the base station 300 and a remote server (not shown) and/or the robot 100. Information that may be transmitted and/or received between the base station 300 and the remote server include, but is not limited to, updated nutrient delivery tasks, weather information, general system status updates or anti-theft information.

The base station 300 may further include a battery box 304 which may be seen as a set of batteries. The set of batteries 304 may be solar powered whereby when some or all of their power is depleted, they are re-charged using solar power panels 305. In one specific embodiment, battery box 304 includes three solar panels 305 that are connected to two car batteries in the battery box 304 for energy storage. When the robot 100 returns to the base station 300, the robot 100 engages a charging and refill station 306 (connected to battery box 304) where the robot's battery can be re-charged. In one embodiment, the charging and refill station 306 includes a set of charging pads, such as a set of copper charging pads, whereby engagement of the robot 100 with these charging pads initiates the re-charging process. The charging and refill station 306 may include guidance apparatus to facilitate connection between the robot and the charging station for charging to occur.

The base station 300 may also include a washing station 310 into which the robot can enter so that it can be cleaned before the next nutrient delivery task is initiated. This enables any dirt or other debris to be cleaned from surfaces to reduce the likelihood of damage and/or wear and tear on the robot 100 and to prolong the life of the robot or to reduce the amount of time that the robot may need to be in maintenance.

In some embodiments, the disclosure maintains continuous awareness of environmental conditions through sensors (not shown) located in the base station and the sensors 116 that are integrated or mounted on the robot. Examples of sensors that may be included or integrated within the base station include, but are not limited to, soil moisture sensors, soil temperature sensors, air temperature sensors, air pressure sensors, air humidity sensors, rain sensor, light intensity sensor, tank level sensors, flow sensors, pump motor position sensors, security cameras, solar array power sensor and/or a battery feedback sensor.

Base station 300 may also retrieve/receive current weather conditions or future weather conditions or both by communicating with a weather information database or server via the communication mechanism 303. Although not shown, a server or processing unit may be present at the base station 300 to perform different functionalities including, but not limited to, transmitting and/or receiving instructions, processing information, updating a nutrient management plan and the like. In some embodiments, the base station 300 may operate as a central environmental monitoring hub, tracking weather patterns and soil conditions to optimize or improve nutrient delivery timing or to update the nutrient management plan.

FIG. 3b provides a perspective view of another embodiment of a base station. As shown in FIG. 3b, the base station 300 includes an antenna 320 for use in communications and/or for use in GPS RTK location functionality. Although one antenna is shown, it is understood that antenna 320 may be implemented via a set of antennas. A set of solar panels 322 are located on a roof or top of the base station 300 to generate power for re-filling batteries 324 that are used to charge the robot or robots upon their return to the base station 300. The power generated by the solar panels 322 and/or the power stored in the batteries 324 may also be used to charge components within the base station, where necessary and not just the robot(s). The base station 300 further includes a control station 326 which may be used to control a security system 328 and lights 330 around the base station 300 and other communications between the base station and the robot or other external parties. The control station 326 may also serve as a central hub all tasks. A set of nutrient tanks 332 store different nutrients that are used to replenish the storage tanks within the robot or robots when they return to the base station. In some embodiments, at least one of the set of nutrient tanks 332 may store water.

The base station 300 may also include a set of sensors 334 such as soil sensors 334a and/or weather sensors 334b for obtaining different analytical information for use in generating the nutrient delivery plan. Within the base station 300 is a charging or docking station 336 where the robot can receive a battery charge and/or nutrient re-fill.

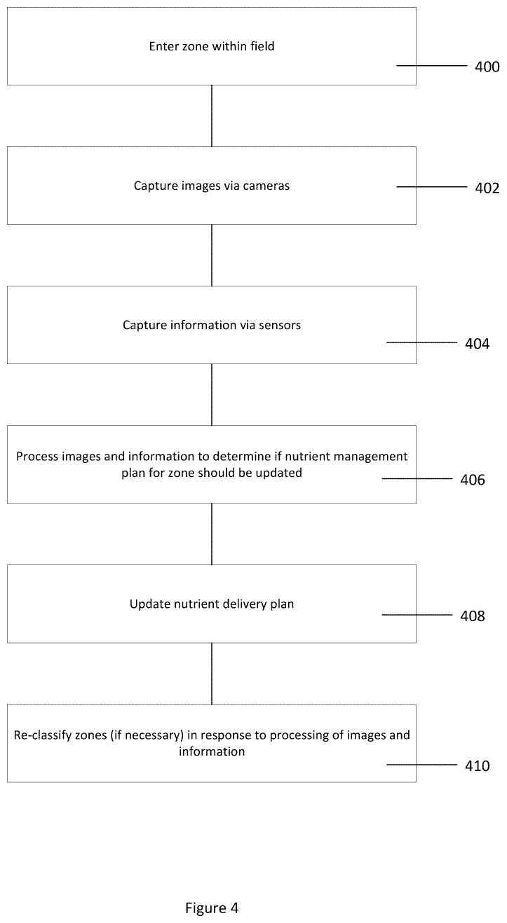

Turning to FIG. 4, a flowchart showing a method of performing and/or updating a nutrient delivery management plan based on zone methodology is shown. As understood, a nutrient delivery process or task may be seen as one where the robot 100 travels from the base station to a field and then delivers nutrients in accordance with a closed-loop nutrient management plan that is based on a dynamic zones methodology. In some embodiments, the disclosure provides a sophisticated approach to precision agriculture that continuously adapts to changing field or crop conditions in an uncontrolled environment. In some embodiments, the robot may traverse the field to obtain different information from the cameras and sensors without having to perform a nutrient delivery task.

Generally, the robot may be seen as operating through four interconnected stages that form a continuous feedback loop. Initially, the robot delivers nutrients to the different zones according to the nutrient management plan. In other words, the robot delivers nutrients at variable rates where nutrients are precisely applied based on distinct productivity zones or based on the zone classifications enabling each area to receive an optimized or a predetermined level of nutrient or nutrients. As the nutrients are being delivered, the robot also performs a field response to monitor plant growth. This may be performed over a predetermined time frame such as, but not limited to, five to seven day cycles to validate growth stages to understand how plants respond or are responding to the applied nutrients. The robot may also perform real-time monitoring via the array of sensors and cameras (RGB, multispectral, temperature, moisture, rainfall, wind, and light) to collect detailed data about plant or crop characteristics and environmental conditions. Finally, the robot (or the system in concert with the robot) performs dynamic optimization whereby the collected data is used to validate performance against thresholds and automatically update the nutrient management plan for the next application cycle or the current nutrient delivery task.

As the robot traverses the field, the robot enters one of the zones (400). As previously discussed, the zones are predetermined (along with the location of the high and low growth calibration points) and stored within the memory of the robot which may use GPS technology to recognize the boundaries of each of the zones. Therefore, the robot understands which zone it is in and the location of the high and low calibration points within the zone. In another embodiment, the field may include physical markers that indicate where one zone ends and another zone starts whereby the robot includes a sensor for locating these physical markers or for sensing the physical markers to understand or recognize which zone the robot is in during a nutrient delivery task.

The system has previously stored information associated with the different zones that are used to assist in the determination of how much nutrient to apply to the crops within a zone. This may be in the form of previously stored images of the high and low growth calibration points, previous nutrient management plans, weather patterns, results from a soil test determining a baseline soil potential and the like. This previously stored information may be used to determine a current nutrient management plan based on zones. The previously stored digital information may include, but is not limited to, high-density soil samples characteristics information, historical yield data, field elevation data, historical rotation information, water holding capacity data and or cation exchange capacity (CEC) measurements. The previously stored digital information may also include analytics with respect to previous nutrient delivery levels or the health of the crops in previous analysis. Furthermore, the previously stored digital information may include zone classifications (such as outlined above) that have been assigned to each of the zones in respect of previously performed analysis. In some embodiments, a variable map may be generated based on the properties of the soil in the field. The system may also generate a crop update curve based on real-time weather forecast, crop or seed variety or type and/or location of the field to assist with the generation of the nutrient delivery plan.

Prior to the start of the nutrient delivery tasks, an initial nutrient management or delivery plan may be downloaded or transmitted to the robot with respect to each of the zones or the entire field. In some embodiments, the initial nutrient management or delivery plan may be updated in response to a real-time weather forecast.

As the robot travels within the zone delivering nutrients, the set of cameras captures different images surrounding the robot (402). For example, these images may include, but are not limited to, images of the crops and/or images of environmental conditions, such as, but not limited to, sky conditions. The images may be taken of crops in front of, behind, above or below the robot. Concurrently or consecutively, the sensors that are integrated within the robot collect different sensor information (404) such as, but not limited to, information about crop condition, conditions of the soil, environmental conditions, temperature, humidity and the like.

The images and the sensor information are then processed by the system to determine if the current nutrient management plan for the zone should be updated (406). In one embodiment, the processing of the images and the sensor information may be used to determine certain crop conditions by comparing the images with pre-stored images. In other embodiments, images of the crops outside of the high and low growth calibration point areas are compared with images of crops within the high and low growth calibration point areas to determine how crop growth is going. The comparison between the different images or sensor information may be performed using artificial intelligence such as in the form of machine learning. In one embodiment, images may be compared to determine if there are expected plant markers or plant markings on the leaves of the crops which may indicate high or low growth. In other embodiments, the images may be compared to determine a height of the crops with respect to the high or low growth checkpoint images. It is understood that each zone may have more than two calibration points. In some embodiments, the processing of the digital information may include processing Normalized Difference Vegetation Index (NDVI)/crop tissue data.

In some embodiments, this processing may be performed in real-time so that the nutrient management plan may be updated in real-time. The processing may be performed by the CPU 109 or the digital images and sensor information may be transmitted to a remote server (or the base station) to process the digital images and sensor information. The remote server may then communicate with the robot to update the nutrient management plan in real-time or may store the results of the processing to update the nutrient management plan prior to the next scheduled nutrient delivery task. If needed, the nutrient delivery or management plan may be updated based on the processing of the images and sensor information (408).

The system may then update the nutrient management plan for the zone (408) based on the processing performed in (406). This information may also be used to re-classify the zones based on current conditions (410). The zones may also be re-classified based on the processing of the images and sensor information.

In some embodiments, processing of the images and sensor information (collectively referred to as “zone information”) may result in a “high” health level determination or classification or a “low” health level determination or classification. This may be with respect to the crops or to specific variables that are being monitored by the system. In some embodiments, the processing of the zone information or zone classification may relate to a set of calibration points designated within each zone. The system may determine the health of the crops at these calibration points to assign a health level (i.e. high or low) to each calibration point. As outlined above, if there are two calibration points in a zone, the results may be “high-high”; “high-low”; “low-high” or “low-low”.

In some embodiments, the zone classification may be performed on a dynamic basis as the robot is performing nutrient delivery. In other embodiments, the zone classification may be performed between nutrient delivery tasks where the nutrient management plan is updated after the robot returns to the base station.

One aspect of novelty of the disclosure includes the combining or combination of dynamic field-based adjustments with a calibration point validation system. While standard variable rate applications exist, the closed-loop algorithms that weigh the impact of multiple variables remain largely proprietary and black-box. With the current disclosure, the disclosure includes systematically testing variable weightings against real-world checkpoint performance, enabling continuous improvement. Collection of calibration point data by the robot, enables the nutrient management plan to be updated based on observed results creates a truly adaptive system that optimizes nutrient delivery in real-field conditions where countless variables interact in complex ways that static models cannot fully predict.

With respect to calibration point determination, in some embodiments, the processing of the images may be used to perform a plant or crop health analysis during field traversal. In a specific embodiment, the robot captures detailed imagery and processes multiple data streams simultaneously. Using a known row spacing as a calibration reference, the disclosure can accurately measure physical plant characteristics while also assessing physiological parameters such as, but not limited to, chlorophyll content and nutrient status. These measurement parameters may include plant density calculation; stem width measurement; leaf count per plant; chlorophyll level assessment (40-50 mg/L range); nutrient deficiency detection and/or disease monitoring.

In some embodiments, the robot may collect image and sensor information by traversing the field even when no nutrient delivery is being performed whereby the robot may be seen as gathering information for updating the nutrient management plan based on the zone methodology.

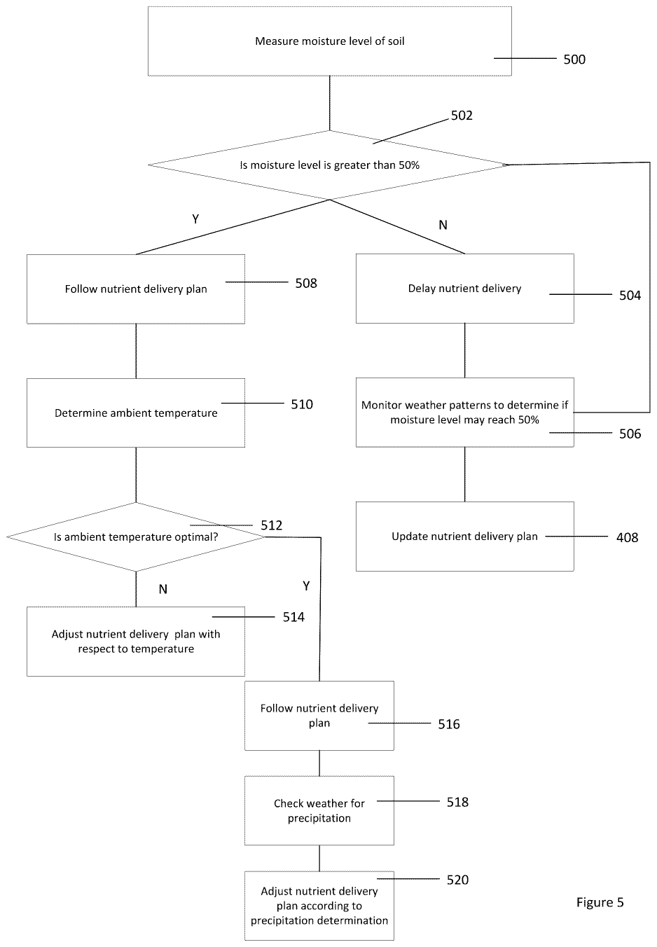

Turning to FIG. 5, a flowchart showing a method of soil moisture level determination is shown. In the field of crop growing, it is beneficial to maintain soil moisture levels around 50% for optimal nutrient absorption. It is also beneficial to pair this with temperature pattern monitoring to maximize or increase nutrient mineralization rates.

In order to determine the soil moisture level to assist in nutrient application or determination of a nutrient management plan, it is assumed that at least one of the sensors that has been integrated within the robot is a moisture sensor. As the robot travels within a zone, the robot obtains a moisture level of the soil (500). In some embodiments, the robot may obtain this information via a humidity level in the field or the robot may use a moisture sensor to determine the moisture level in the field or may communicate with the base station to obtain the moisture level. The system then determines if the moisture level is greater than or less than a predetermined threshold (502).

If the system determines that the moisture level is less than the predetermined threshold, the system then instructs the robot to delay application or delivery of the nutrients (504). The system may then monitor temperature patterns to determine if there is any rain or precipitation in the forecast where the moisture level may increase to over the predetermined threshold (506). If there is rain in the forecast, the system may instruct the robot to obtain a soil moisture level at a predetermined time to determine if the moisture level then meets the threshold.

If the system determines that the moisture level is greater than the predetermined threshold, the system instructs the robot to follow the nutrient management plan to deliver the nutrients (or may simply do nothing if the robot has been previously instructed to deliver the nutrients or may update the nutrient management plan based on this measurement) (508). The system may then determine an ambient temperature (510). In one embodiment, this may be performed by retrieving data from a temperature sensor that is integrated with the robot.

The system then determines if the ambient temperature is at an optimal level (512). If the system determines that the temperature is at a sub-optimal level for nutrient delivery, the system adjusts the rate of nutrient delivery in accordance with the sensed temperature (514). If the system determines that the temperature is at an optimal level for nutrient delivery, the system instructs the robot to follow the nutrient management plan to deliver the nutrients (or may simply do nothing if the robot has been previously instructed to deliver the nutrients) (516).

If the nutrient delivery process is continued, the system may then check a weather forecast (518). In one embodiment, depending on the weather forecast, the nutrient management plan may be adjusted according to a precipitation determination (520). For example, if the weather forecast indicates clear weather, the system may instruct the robot to follow the nutrient management plan to deliver the nutrients (or may simply do nothing if the robot has been previously instructed to deliver the nutrients). If the weather forecast indicates rain is expected, the system may update the nutrient management plan to deliver the nutrients at a reduced rate.

In some embodiments, the disclosure is directed at a sophisticated decision-making process to determine optimal or improved nutrient delivery timing based on different environmental and plant or crop health factors. By integrating weather forecasts, soil conditions, and plant development stage, the robot can maximize or increase the efficiency of nutrient delivery while minimizing or reducing potential losses due to environmental factors.

In some embodiments, determining nutrient management may include processing or analyzing different parameters including, but not limited to, timing considerations; current soil moisture status; weather forecast integration; temperature conditions; growth stage validation and/or zone-specific requirements.

With respect to nutrient management plan updates, especially when dynamically performed in the field, nutrient application rates or delivery rates may be dynamically adjusted based on real-time field conditions and zone performance data and processing of the digital information obtained by the robot. The system continuously compares actual plant or crop performance against expected responses, using the calibration point comparisons to validate and adjust application strategies. Some parameters that may be taken into account with respect to changing a delivery rate of nutrients may include, but are not limited to, zone classification impact; crop uptake curve position; real-time sensor feedback and/or checkpoint comparison results.

Another functionality that is provided by the disclosure is performance monitoring which includes a continuous improvement cycle through sophisticated performance monitoring and adaptive algorithms. Every time a robot traverses a field or zone, the system generates performance data that is analyzed against established benchmarks and checkpoint comparisons, enabling dynamic system optimization. In order to implement this functionality, the analysis may include real-time performance tracking; checkpoint comparison analysis; yield potential calculations and/or response rate monitoring.

With respect to the zone re-classification methods, in one embodiment, the zone reclassification system employs a dynamic approach to updating management zones based on observed performance patterns. When significant performance deviations are detected, the system initiates a reclassification process that considers multiple factors before implementing changes.

Advantages of the current include, but are not limited to, real-time adaptation with respect to field conditions for nutrient delivery; self-correcting zone classification; robust fail-safe capabilities; comprehensive data integration and/or automated optimization. The disclosure may also be adapted for different crop types; various field sizes; multiple robot configurations; alternative sensor arrays and/or different application or nutrient delivery systems or mechanisms.

In some aspects, the disclosure is directed at an agricultural management system including at least one of a mobile robotic platform including a GPS guidance system with RTK capability; a multi-sensor array including at least one of moisture sensors; temperature sensors; multispectral cameras; RGB-IR cameras; or canopy sensors; a variable-rate nutrient application or delivery system; and autonomous navigation capabilities; a base station including a weather monitoring station; soil monitoring probes; a solar power system; a communication system; and a data processing unit; and/or a zone management system configured to establish a predetermined number of discrete productivity levels; implement cross-zone calibration points; dynamically adjust zone classifications; and process historical and real-time data.

The nutrient application system may calculate optimal nutrient delivery timing using soil moisture levels and/or temperature conditions and/or weather forecast data; determine application or delivery rates based on crop stage (verified through visual data) and/or zone productivity level and/or cross-zone performance comparison; and/or implements adaptive application protocols.

The zone classification system may analyzes historical data; process high-density soil sampling data; map multiple field characteristics including organic matter content and/or water holding capacity and/or cation exchange capacity and/or elevation; and/or establish performance checkpoints.

The system may further include a machine learning subsystem that implements computer vision algorithms for at least one of crop/non-crop classification; plant counting and measurement; disease detection; and/or nutrient deficiency identification; and processes sensor data to calculate relative dimensions using row spacing; generate health indices; detect anomalies and/or predict yield potential.

The system may further include a fail-safe system that implements redundant navigation through at least one of primary RTK GPS; computer vision row following; and/or remote operation capability; and/or manages communications via at least one of a connection mechanism, a LTE backup; local data storage and/or automated failover protocols.

In another aspect, the disclosure includes a method of implementing a nutrient management deliver system including initial setup which includes field data collection and analysis; zone establishment; checkpoint designation, and/or system calibration; and operational execution including autonomous navigation; real-time data collection; prescription adjustment and/or performance monitoring.

The cross-zone validation may include comparing performance metrics between zones; triggering nutrient delivery adjustments; initiating agronomist inspection and/or updating zone classifications.

The data management system may anonymize collected data; implement secure storage; enable selective sharing and/or maintain audit trails.

In other embodiments, although the description focusses on the use of a single robot to deliver nutrients to crops in a field, it is understood that any nutrient delivery management plan can be performed by multiple autonomous platforms operating cooperatively under centralized or distributed coordination, including task allocation and field coverage optimization.

Applicants reserve the right to pursue any embodiments or sub-embodiments disclosed in this application; to claim any part, portion, element and/or combination thereof of the disclosed embodiments, including the right to disclaim any part, portion, element and/or combination thereof of the disclosed embodiments; or to replace any part, portion, element and/or combination thereof of the disclosed embodiments.

The above-described embodiments are intended to be examples only. Alterations, modifications and variations can be effected to the particular embodiments by those of skill in the art without departing from the scope, which is defined solely by the claims appended hereto.

What is claimed is:

1. A method for generating a nutrient management plan for crops in a field comprising:
selecting high and low growth calibration points withing the field;
obtaining high and low growth calibration point images;
obtaining digital information associated with the crops while delivering nutrients to the crops in the field;
processing the digital information; and
updating the nutrient management plan based on the comparison.

2. The method of claim 1 wherein obtaining digital information associated with the crops comprises:
obtaining images or a video stream of crops within the field.

3. The method of claim 2 wherein obtaining images or a video stream of crops within the field comprises:
obtaining images or video stream of crops above and below the robot.

4. The method of claim 1 wherein obtaining digital information associated with the crops comprises:
determining at least one of weather conditions or soil conditions within the field.

5. A system for nutrient delivery comprising:
a set of wheels;
at least one storage tank for storing at least one nutrient for the nutrient delivery;
a nutrient delivery component;
a set of cameras; and
a processor for storing and controlling the system for nutrient delivery to execute a nutrient delivery plan based on zoned methodology.

6. The system for nutrient delivery of claim 5 wherein the set of cameras comprises at least one of a multispectral camera, a hyperspectral camera or a RGB camera.

7. The system for nutrient delivery of claim 5 further comprising:
a set of sensors.

8. The system for nutrient delivery of claim 7 wherein the set of sensors comprises at least one of temperature sensors, humidity sensors, pressure sensors, inertial measurement unit (IMU) sensor, a compass, a motion position sensor, a pump position sensor, a tank level sensor, flow/liquid flow measurement sensors or a battery level or feedback sensor.

9. The system for nutrient delivery of claim 5 further comprising a set of charging pads.

10. The system for nutrient delivery of claim 5 wherein the nutrient delivery component comprises a nozzle module for delivering the nutrients.
